(19) United States
(12) Patent Application Publication
(10) Pub. No.: US 2026/0292951 A1
(43) Pub. Date: Sep. 24, 2026

(54) AN LED DRIVING ARRANGEMENT

(71) Applicant: SIGNIFY HOLDING B.V., EINDHOVEN (NL)

(72) Inventors: JIE FU, SHANGHAI (CN); ZHIQUAN PTO/AIA/14 (01-22) Approved for use through 05/31/, SHANGHAI (CN); HAIYING ZHOU, SHANGHAI (CN); GANG WANG, SHANGHAI (CN)

(21) Appl. No.: 19/484,428

(22) PCT Filed: May 8, 2024
(86) PCT No.: PCT/EP2024/062678

§ 371 Date: Nov. 14, 2025

(30) Foreign Application Priority Data
May 16, 2023 (WO) PCT/CN2023/094510
Jul. 3, 2023 (EP) 23182958.1

(51) Int. Cl. H05B 45/36; H05B 45/355; H05B 45/375; H05B 45/38

(52) U.S. Cl. CPC H05B 45/36; H05B 45/355; H05B 45/375; H05B 45/38

(57) ABSTRACT

Provided is driving arrangement for LED lighting that adaptively adjusts output voltage of a power factor correction (PFC) circuit to improve total harmonic distortion (THD), improve efficiency, and extend dimming performance. More particularly, the PFC circuit and an auxiliary switched mode power supply (SMPS) with outputs connected in series superimposes their outputs to a load, the PFC circuit also changes its output amplitude modulation modes responsive to an input rectified AC voltage in a sub-optimal range which can not satisfy an operating condition, between the rectified AC voltage and the PFC output voltage, of the PFC circuit. Accordingly, with the changed output amplitude modulation the operating condition is satisfied and the PFC circuit may maintain normal operation for a larger amount of time in the cycle of the rectified AC input voltage. And the auxiliary switched mode power supply also changes its output amplitude modulation modes and helps to keep the total output to the load constant.

### FIELD OF THE INVENTION

The present invention relates to the field of lighting, and in particular, to the field driving arrangements for lighting.

### BACKGROUND OF THE INVENTION

Driving arrangements have burdensome power factor (PF) and total harmonic distortion (THD) requirements to ensure effective operation. Such driving arrangements consume large amounts of power, thus significantly influencing the power grid. Typically, a power factor correction (PFC) circuit is used in LED driving arrangements to achieve a high PF and a low THD. Different types of topologies can be selected for use as a PFC circuit, such as buck converters, boost converters, etc.

In driving an LED arrangement using such a driving arrangement, the output voltage of the PFC circuit is often limited/clamped by the relatively/substantially fixed forward voltage of any LEDs in the LED arrangement. But in order to maintain operation for many types of PFC circuit, there is a certain condition between the input voltage and the output voltage. This condition often conflicts with the relatively fixed forward voltage of LEDs.

More specifically, for a buck PFC circuit, a high output voltage is preferred for driving the LED arrangement in order to improve efficiency. However, a high output voltage leads to a greater THD due to the necessity of a long deadtime since the buck PFC circuit is unable to operate when the input voltage is less than the output voltage. Accordingly, balancing THD and efficiency proves challenging. Some applications (e.g., TLED) have strict THD requirements whilst also requiring a high efficiency, and therefore meeting this challenge may be critical for viable operation.

For boost PFC circuits, a PFC output voltage needs to be greater than the maximum peak voltage of the AC input to guarantee normal operation of the circuit. In particular, for dimmable lighting applications, an LED forward voltage drops quickly as an LED current drops. For example, when operating at a full load (i.e., undimmed) condition, the LED forward voltage is usually designed to be higher than the AC input voltage. However, in a dimmed condition, the LED forward voltage drops, and so does the boost PFC output voltage. When the PFC output voltage is lower than the (peak of) the AC input voltage, the boost does not work effectively. In some cases, the voltage at 10% lumen load may only be approximately 50%-60% of that at full load (i.e. undimmed) conditions. Simply put, it is difficult to design an effective boost PFC for a dimming circuit at deep dimming condition, as a very high voltage bulky E-CAP and MOSFET are required, having an undesirably high cost and large size.

Thus, there exists a need for a driving arrangement for LED lighting that can provide a low THD with an appropriate efficiency, as well as a driving arrangement that allows for cost-effective dimming of the LED lighting.

US 2017/0288557A1 discloses a single stage power converter for driving LED, wherein there is a first output circuit mainly for power factor correction and generating a first output, and a second output circuit to generate a second output to be superimposed with the first output for substantially cancelling the ripple in the first output, as seen by the load. FIG. 1 schematically shows the architect.

### SUMMARY OF THE INVENTION

The basic idea of the present invention is using the so-call ripple remover SMPS converter, similar as the second output circuit in the aforementioned prior art, to help relieve the constraint of the LED forward voltage over the PFC circuit. More specifically, when the input voltage is in a sub-optimal range which can not satisfy the abovementioned operating condition between input voltage and output voltage of PFC circuit, the output voltage of the PFC circuit can be overridden to have a special amplitude pattern that satisfies the condition so as to keep the PFC circuit operating. Meanwhile, the ripple remover SMPS converter kicks in to generate an extra signal pattern so as to compensate the special amplitude pattern in the overridden output voltage of the PFC circuit, such that the superimposed output voltage of the PFC circuit and the output voltage of the SMPS converter is still smooth and reduces/avoids flicker in the a driven LED arrangement. In the prior art, the SMPS converter is designed to compensate only the natural PFC ripple in the PFC output voltage, instead of compensating a special amplitude pattern in the overridden PFC output voltage.

The invention is defined by the claims.

According to an aspect of the invention, there is provided a driving arrangement for LED lighting, comprising: an input adapted to receive a rectified AC voltage having a first ripple corresponding to a frequency of the rectified AC voltage; a power factor correction, PFC, circuit configured to be operable in a first PFC amplitude modulation mode in which the PFC circuit converts the rectified AC voltage into a PFC output voltage for implementing power factor correction, the PFC circuit comprising a following circuit to make the PFC output voltage having a second ripple corresponding to the frequency of the rectified AC voltage and following the first ripple; and an auxiliary switched mode power supply, SMPS, configured to generate an offset signal provided in series with the PFC output voltage to produce a superimposed signal for application to a load, wherein the auxiliary SMPS is configured to be operable in a first SMPS amplitude modulation mode to generate, in the offset signal, a third ripple out of phase with the second ripple such that the superimposed signal has a smoothed second ripple, and wherein, responsive to the rectified AC voltage in a sub-optimal range which can not satisfy an operating condition, between the rectified AC voltage and the PFC output voltage, of the PFC circuit: the PFC circuit is further configured to switch from the first PFC amplitude modulation mode to a second amplitude modulation mode in which the PFC circuit further comprising a generating circuit to generate in the PFC output voltage a first signal pattern corresponding to the frequency of the rectified AC voltage and different from the second ripple, with which first signal pattern the operating condition is satisfied so as to keep the PFC circuit operating; and the auxiliary SMPS is further configured to switch from the first SMPS amplitude modulation mode to a second SMPS amplitude modulation mode in which the auxiliary SMPS generates a second signal pattern in the offset signal, the second signal pattern different from the third ripple and adapted to compensate for the first signal pattern.

Proposed embodiments of the invention are based on the realisation that, for some rectified AC voltage amplitudes, a PFC circuit (e.g., a buck or boost converter) and auxiliary SMPS (e.g., a mini converter) may not provide a satisfactory output voltage to the load (e.g., an LED arrangement). Thus, when the rectified AC voltage is in the sub-optimal range, the PFC circuit and auxiliary SMPS each switch to a second mode of operation in which they output signal patterns different from their normal/regular mode of operation.

By altering the outputs of the PFC circuit and auxiliary SMPS responsive to the rectified AC voltage in the sub-optimal range (i.e., a predetermined voltage window), then the total harmonic distortion (THD) and efficiency of the driving arrangement may be improved, meanwhile there is reduced/avoided flicker in the final output for the LED arrangement. That is, responsive to some input AC voltages, a PFC circuit operating normally may perform poorly with respect to efficiency and THD. One manner to solve this problem is to alter the output voltage of the PFC circuit, however this may have a negative impact on the power to the LED arrangement and necessity for costly additional components.

Therefore, enabling the PFC circuit and auxiliary SMPS to switch to a second mode of operation may on one hand facilitate a decrease in the downtime of the PFC circuit, lower a THD and improve an efficiency (depending on the topology of the PFC circuit (e.g. buck converter, boost converter, etc.) by making the PFC circuit operate in an output-squeezed manner or output-expanded manner and on the other hand maintaining the total/superimposed output to the LED stable by making the auxiliary SMPS operate in an output-expanded manner or output-squeezed manner that is complementary to the output-squeezed manner or output-expanded manner of the PFC circuit.

In some embodiments, the PFC circuit operating in the second amplitude modulation mode may be adapted to modify the amplitude of the PFC output voltage provided in the first PFC amplitude modulation mode so as to maintain operation when a difference between the amplitude of the rectified AC voltage and a voltage at the load is less than a threshold voltage.

That is, when a difference between the rectified AC voltage and load voltage is less than a threshold, in the prior art the PFC circuit is not able to operate. By comparison, the embodiments of the invention modify the amplitude of the PFC output voltage of the PFC circuit to maintain the operation of the PFC circuit. Accordingly, an overall THC and efficiency of the driving arrangement may be improved. Implicitly, the modified amplitude of the PFC output voltage is compensated by the auxiliary SMPS.

More specifically, in some cases the PFC circuit may be adapted to operate when the difference is less than the threshold voltage by allowing a further difference between the amplitude of the rectified AC voltage and the PFC output voltage within an operable range of the PFC circuit, thereby ensuring the PFC circuit maintains operation when the amplitude of the rectified AC voltage is different from the voltage amplitude of the load at least by said difference.

By ensuring that the PFC circuit maintains operation when an amplitude of the rectified AC voltage and amplitude of the load exceeds a certain amount, an overall downtime of the circuit within a cycle of the rectified AC voltage may be reduced.

In some embodiments, the PFC circuit may be configured to switch between the first PFC amplitude modulation mode and the second amplitude modulation mode within each cycle of the rectified AC voltage, and the auxiliary SMPS is configured to switch between the first SMPS amplitude modulation mode and the second SMPS amplitude modulation mode within each cycle of the rectified AC voltage.

That is, the PFC circuit and auxiliary SMPS are configured to switch operation modes at least once within each cycle, therefore compensating for the periodical instantaneous voltage change of the rectified AC voltage within each cycle (improving THC, efficiency and downtime). In this case, the patterns are in short term.

In an alternative embodiment, if the RMS amplitude of rectified AC voltage is varying in relatively long term due to unstable utility, the embodiment of the invention could also be used. For example, in off-peak hours, the RMS amplitude of the rectified AC voltage may be relatively medium such as 220V, and the driving arrangement works in its rated input and works well without kicking the second amplitude modulation mode and the second SMPS amplitude modulation; in valley hours, the RMS amplitude of the rectified AC voltage may be relatively high such as 240V and the driving arrangement may kick in the second amplitude modulation mode and the second SMPS amplitude modulation. For example, if the PFC circuit is a step-up converter, the PFC output can be modulated into a pattern with a higher average value in valley hours so as to make the step-up converter operate as long as possible. In this case, the pattern is in long terms. Most importantly, the auxiliary SMPS would decrease the offset signal in such a way that the superimposed signal to the load is still the same.

Further, the PFC circuit may be a step-down converter. Thus, the sub-optimal range may comprise the rectified AC voltage falling below a first threshold voltage. In this case, the first signal pattern may be a voltage downward pulse with respect to the second ripple, and the second signal pattern may be a voltage upward pulse.

As outlined above, a high output voltage is preferred in order to improve efficiency. However, when the PFC circuit is a step-down converter, this increases PFC circuit deadtime, thus increasing THD. In order to solve this problem, the PFC circuit is allowed to output a decreased output voltage to match the decreasing rectified AC voltage, this embodiment of the invention enables a driving circuit with low THD and high efficiency as the PFC circuit and auxiliary SMPS switch modes of operation when the rectified AC voltage falls below a threshold voltage, enabling the circuit to run for longer. Therefore, this enables a reduced deadtime, improved THD, whilst having a high output voltage for improved efficiency.

The step-down converter may be a buck converter, and the first threshold voltage may be equal or less than a forward voltage of the load, thereby the PFC circuit is able to keep operating when the amplitude of the rectified AC voltage is less than the forward voltage of the load.

Alternatively, the PFC circuit may be a step-up converter. In this case, the sub-optimal range may comprise the rectified AC voltage exceeding a second threshold voltage, the first signal pattern may a voltage upward pulse with respect to the second ripple, and the second signal pattern may be a voltage upward pulse.

As described, for a step-up converter, a PFC output voltage needs to be greater than the maximum peak voltage of the AC input to guarantee normal operation of the circuit. This becomes particularly relevant for dimmable LED arrangements, where the output voltage of the PFC circuit may need to be much lower than during normal operation. However, by switching the operation mode of the PFC circuit to provide a higher output voltage when the AC voltage exceeds a certain level, the PFC circuit may continue to function whilst the rectified AC voltage is approaching or even greater than the forward voltage of the load. This may enable normal operation of the driving circuit even during deep diming of LEDs as the load (without requiring a costly and bulky E-CAP and MOSFET). The second pattern is a reduced amplitude or even a negative amplitude in the offset signal so as to be complementary with the increased output voltage of the PFC circuit so as to provide the desired LED voltage.

In particular, the step-up converter may be a boost converter, and the second threshold voltage may be equal or greater than a forward voltage of the load, thereby the PFC circuit is able to keep operating when the amplitude of the rectified AC voltage is approaching or even higher than the forward voltage of the load.

In some embodiments, the PFC circuit may be configured to switch from the first PFC amplitude modulation mode to the second amplitude modulation mode and the auxiliary SMPS may be configured to switch from the first SMPS amplitude modulation mode and the second SMPS amplitude modulation mode responsive to the rectified AC voltage in the sub-optimal range, under a condition that a forward voltage of the load meets a predetermined requirement. Otherwise, the PFC circuit may be configured to stay in the first PFC amplitude modulation mode and the auxiliary SMPS may be configured to stay in the first SMPS amplitude modulation mode even responsive to the rectified AC voltage in the sub-optimal range.

That is, in different working state, the forward voltage of the LED load may vary. In some states the forward voltage and the rectified AC voltage in the sub-optimal range is still with acceptable relationship for the operation of the PFC circuit, while other states not. Therefore the driving circuit may only be configured to change modes of operation when the forward voltage of the load is such that issues (of deadtime, unsuitable operation, etc.) discussed above may arise and may keep the original mode otherwise. This can provide a flexible driving arrangement achieving optimal performance in all of the different working states.

In particular, the PFC circuit may be a step-down converter, and the predetermined requirement may be met when the forward voltage of the load is higher than a first voltage level when the PFC circuit is a step-down converter.

Alternatively, the PFC circuit may be a step-up converter, and the sub-optimal range may comprise the amplitude of the rectified AC voltage exceeding a forward voltage of the load, and the load may be an LED and wherein the forward voltage of the load meeting the predetermined requirement corresponds to the LED being dimmed down thereby the forward voltage thereof decreases. In this case, the first signal pattern may be a voltage upward pulse with respect to the second ripple, and the second signal pattern may be a voltage downward pulse. The forward voltage of the load meeting the predetermined requirement may correspond to the LED being dimmed down thereby the forward voltage thereof decreases. In this embodiment, when the LED is not dimmed down, its forward voltage is high enough and the PFC circuit without kicking the second amplitude modulation mode can work with good THD. And when the LED is dimmed down, its forward voltage is decreased thus the PFC circuit needs kicking the second amplitude modulation mode to increase its output voltage.

In some embodiments, responsive to the rectified AC voltage no longer meeting the predetermined amplitude condition the PFC circuit may be further configured to switch from the second amplitude modulation mode to the first PFC amplitude modulation mode. Also, the auxiliary SMPS may be further configured to switch from the second SMPS amplitude modulation mode to the first SMPS amplitude modulation mode.

That is, the driving arrangement may switch back to a first (typical/normal) mode of operation when the amplitude condition of the rectified AC voltage no longer applies-ensuring effective and efficient operation of the driving arrangement.

According to another aspect in accordance with the invention, there is provided an LED lighting circuit comprising the driving arrangement according to an embodiment of the invention, and an LED arrangement as the load.

Furthermore, according to further aspects of the invention, there is provided an LED lighting device comprising the LED lighting circuit.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 is a block diagram of a known arrangement for driving LED lighting;

FIG. 2 presents graphs showing waveforms corresponding to the arrangement of FIG. 1;

FIG. 3 is a block diagram of a driving arrangement for LED lighting according to an embodiment of the invention;

FIG. 4 is a block diagram of a driving arrangement for LED lighting according to a further embodiment of the invention.

FIG. 5 presents graphs showing waveforms corresponding to the arrangement of FIG. 4;

FIG. 6 is a block diagram of a driving arrangement for LED lighting according to another embodiment of the invention; and

FIG. 7 presents graphs showing waveforms corresponding to the arrangement of FIG. 6.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. If the term “adapted to” is used in the claims or description, it is noted the term “adapted to” is intended to be equivalent to the term “configured to”.

According to proposed concepts, a number of possible solutions may be implemented separately or jointly. That is, although these possible solutions may be described below separately, two or more of these possible solutions may be implemented in one combination or another.

Provided is a driving arrangement for LED lighting that adaptively adjusts output voltage of a power factor correction (PFC) circuit to improve total harmonic distortion (THD), improve efficiency, and extend dimming performance. More particularly, the PFC circuit and an auxiliary switched mode power supply (SMPS) have outputs connected in series, and change operation modes responsive to an input rectified AC voltage in the sub-optimal range. Accordingly, the PFC circuit may remain operational for a larger amount of time in the cycle of the rectified AC input voltage.

That is, embodiments of the invention provide a mini converter based high power factor (PF), low ripple driver suitable for LED lighting. Embodiments of the invention can adaptively adjust output voltage of a PFC stage to improve THD, with high efficiency. Other embodiments, enable operation of the PFC circuit even during deep dimming of the LEDs attached to the output as load (i.e. the load having a low forward voltage).

It is proposed that the way/mode of modulating the amplitude of the output voltage of a PFC circuit may be adjusted according to a change in input voltage, and preferably further according to a change in a load, Thus, the circuit may have a short deadtime. Meanwhile the mini converter may compensate for the adjusted voltage amplitude to keep the load current/voltage constant in load (i.e. the LED). This can result in an increase in the conduction time, reduce the deadtime of input current, and reduce THD without compromising the load performance. In various embodiments, the PFC circuit is may be either a buck or a boost converter. Other types of converters such as a flyback converter is also applicable as the PFC circuit.

The LED lighting driving arrangement, according to various embodiment, comprises an input adapted to receive a rectified AC mains input voltage with a ripple corresponding to an AC mains frequency. It also includes a power factor correction circuit configured with a first PFC output voltage amplitude modulation mode so as to implement PFC on the rectified AC mains input voltage into an PFC output voltage at an PFC output (said PFC output voltage following the ripple). There is also provided an auxiliary SMPS with an output in series with the PFC output and adapted to use a first auxiliary SMPS voltage amplitude modulation mode to output an offset signal out of phase of the PFC output voltage and to superimpose said offset signal with said PFC output voltage (thereby the superimposed signal smooths the PFC output voltage).

Additionally, embodiments of the invention provide that, when the AC mains input voltage is at a predetermined point or in the sub-optimal range, the PFC circuit is further adapted to switch from the first PFC output voltage amplitude modulation mode into a second output voltage amplitude modulation mode, and generate in the PFC output voltage a signal (pattern) different from a voltage amplitude corresponding to the first output voltage amplitude modulation mode. Further, said auxiliary SMPS is further adapted to use a second auxiliary SMPS voltage amplitude modulation mode to generate in the offset signal a second signal (pattern) for compensating the first signal (pattern).

More specifically, when the PFC circuit is a step-down (buck) converter, one embodiment reduces the buck converter output voltage near zero crossing of the AC mains to shorten the dead time, and the mini ripple remover increases its output voltage to compensate this reduced buck output voltage thereby the total superimposed voltage as well as the current to the load is substantially unchanged.

Alternatively, when the PFC circuit is a step-up (boost) converter, one embodiment increases the boost converter output voltage near peak value of the AC mains to enable boost voltage to operate normally (especially with low LED voltage and a smaller size and lower cost E-CAPs at dimming condition). And the mini ripple remover decreases its output voltage or even reverses the polarity of its output voltage to compensate this increases boost output voltage thereby the total superimposed voltage as well as the current to the load is substantially unchanged. This enables a greater dimming depth. The mini ripple remover decreases output voltage to compensate this increased boost output voltage.

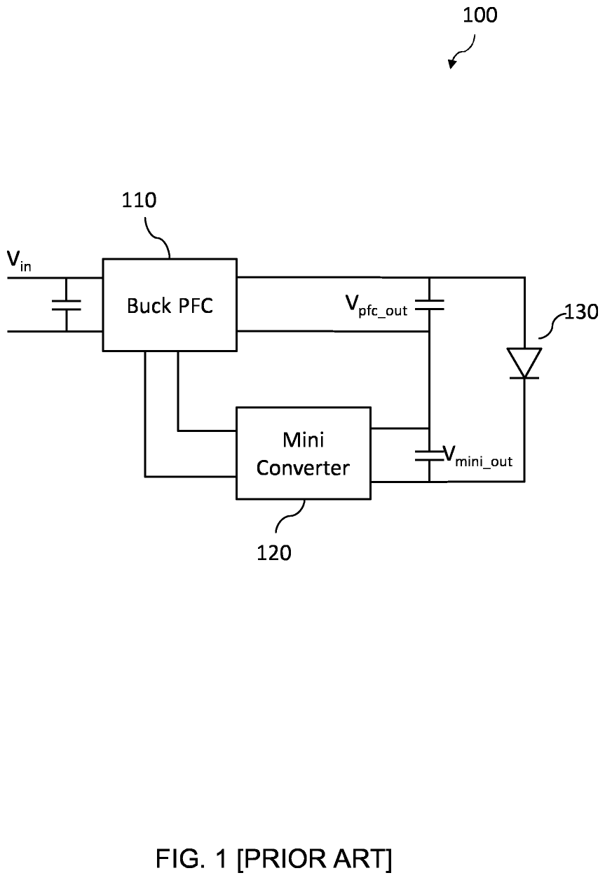

A buck PFC plus mini converter driver architecture is shown in FIG. 1. That is, there is provided a buck-topology PFC circuit 110, and a mini converter 120, and the outputs of the PFC circuit 110 and the mini converter 120 are connected in series with a set of LEDs 130. Note that the input of the mini converter 120 is shown connected within the buck PFC and alternatively it can also connect to the input directly.

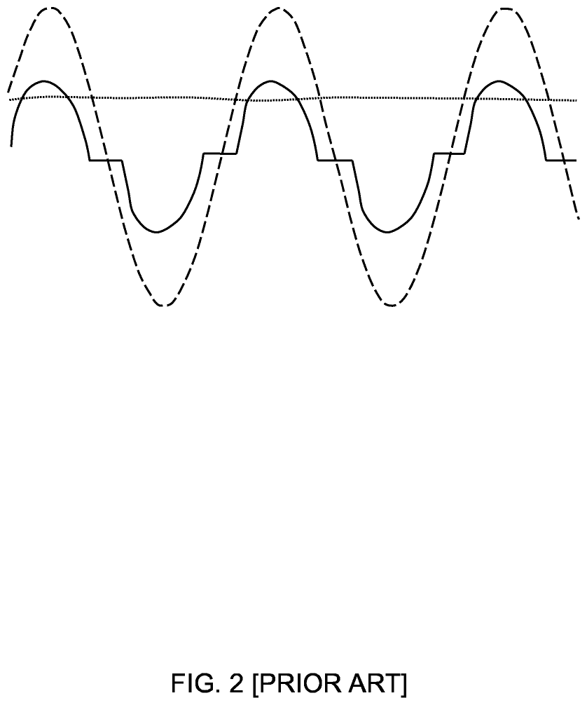

A typical 12 W buck PFC with a mini convertor circuit in the configuration of FIG. 1 was tested, and the shape of the key waveforms are shown in FIG. 2. The PFC output voltage is represented by the dotted line, the dashed line is the input AC voltage, and the solid line is the input current.

From said testing, it was established that, when Vᵢₙ=230V, V_{pfc_out}=128V, V_{led}=144.76V, V_{mini_out}=16V, Pᵢₙ=12.08 W. The efficiency of the driving arrangement is 95.43%, PF is 0.9494, THD is 26.83% and deadtime is 1.5 ms. When Vᵢₙ=230V, V_{pfc_out}=91.5Vdc, V_{led}=103.96V, Pᵢₙ=12.06 W. In this case the efficiency is 94.51%, PF is 0.9678, THD is 16.26% and deadtime is 1 ms.

From this, it is known that a lower output voltage of the PFC circuit (e.g. a buck converter) is needed to meet a requirement that THD<20%, which also results in a lower efficiency. For the given example, the efficiency decreased by 1% when LED voltage decreased from 144.76 Vdc from 103.96 Vdc, while THD decreases from 26.83% to 16.26%. Therefore, this demonstrates the balancing required to achieve adequate THD levels at a satisfactory efficiency.

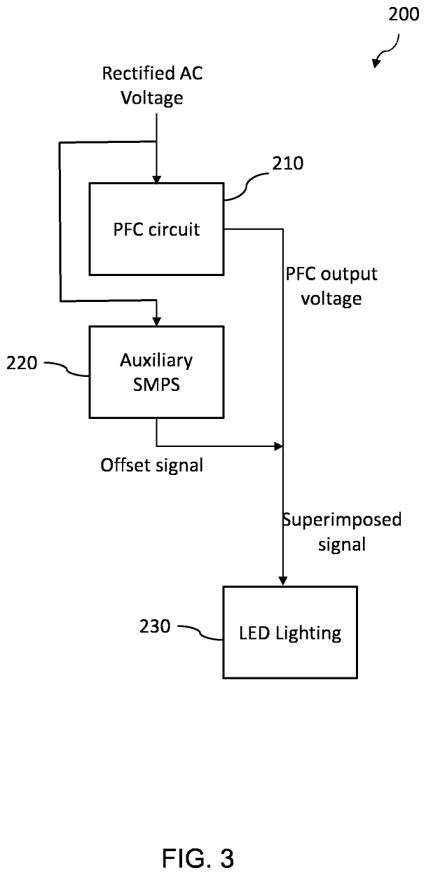

FIG. 3 presents a simplified block diagram of a driving arrangement 200 for LED lighting 230 according to the present invention. The driving arrangement is a system that provides an appropriate current and voltage to the LED from a rectified AC voltage.

The driving arrangement 200 has an input adapted to receive a rectified AC voltage having a first ripple corresponding to a frequency of the rectified AC voltage. That is, an AC voltage that has been rectified may be provided to the input of the driving arrangement. The rectified AC voltage may be obtained from a rectifier (e.g., a full-wave rectifier, or a half-wave rectifier).

Furthermore, the driving arrangement comprises a PFC circuit 210. The PFC circuit 210 is configured to be operable in a first PFC control mode (i.e. a first PFC amplitude modulation mode) in which the PFC circuit 210 converts the rectified AC voltage into a PFC output voltage. As such, the PFC circuit 210 performs power factor correction on the rectified AC voltage. Accordingly, the PFC output voltage has a second ripple following the first ripple (i.e. lagging the first ripple). Such a first PFC amplitude modulation mode for performing power factor correction is a well known technique in the field. For example, a switched mode PFC circuit working in a critical conduction mode usually uses a constant Ton switching scheme.

There is also provided an auxiliary switched mode power supply (SMPS) 220 configured to generate an offset signal. The offset signal is provided in series with the PFC output voltage, thereby producing a superimposed signal for application to a load (e.g. LED lighting 230). The auxiliary SMPS 220 is configured to be operable in a first SMPS control (i.e. amplitude modulation) mode to generate, in the offset signal, a third ripple out of phase (i.e. lagging or leading preferably by 180 degree) with the second ripple. Accordingly, the third ripple is complementary to the second ripple, and the superimposed signal has a smoothed second ripple.

In other words, a PFC circuit 210 and auxiliary SMPS 220 are provided with a rectified AC voltage input, and output voltages connected in series. When the PFC circuit 210 is operating in the first PFC amplitude modulation mode, and the auxiliary SMPS 220 is operating in the first SMPS amplitude modulation mode, a superimposed signal is produced having a smoothed second ripple. The superimposed signal can then be provided to the load, such as LED lighting 230 (i.e., an LED arrangement). This operates in much the same way as a typical driving arrangement for LED lighting.

Importantly, both the PFC circuit 210 and auxiliary SMPS 220 are further configured to switch from first modes of operation to second modes of operation responsive to the rectified AC voltage meeting a certain condition. This may occur substantially simultaneously for both the PFC circuit 210 and auxiliary SMPS 220 (i.e., synchronous switching).

More specifically, the PFC circuit 210 is further configured to switch from the first PFC amplitude modulation mode to a second amplitude modulation mode in which the PFC circuit 210 generates a first signal pattern in the PFC output voltage. The first signal pattern is different from the second ripple.

Put another way, the PFC circuit 210 is further configured to switch from the PFC amplitude modulation mode to a second amplitude modulation mode in which the PFC circuit generates a first signal pattern different from the second ripple, such that the PFC output voltage has the first signal pattern. In this way, the PFC circuit 210 is controlled to generate the first signal pattern as output. The first signal pattern is used for adapting the PFC circuit 210's operation so as to achieve a certain performance. For example, the PFC circuit is able to maintain operation when providing such a first signal pattern, so that the THD is improved.

Furthermore, the auxiliary SMPS 220 is further configured to switch from the first SMPS amplitude modulation mode to a second SMPS amplitude modulation mode in which the auxiliary SMPS 220 generates a second signal pattern in the offset signal. The second signal pattern different from the third ripple, and is adapted to compensate for the first signal pattern so the first signal pattern does not influence or flicker the LED load.

Thus, both the auxiliary SMPS 220 and the PFC circuit 210 change operation modes responsive to the rectified AC voltage meeting a certain condition. The certain condition may be an amplitude of the AC voltage relative to the forward voltage of the load reaching or breaching some predetermined threshold, which threshold may be dependent on the topology of the PFC circuit.

In some cases, it may be beneficial that the PFC circuit 210 is configured to switch between the first PFC amplitude modulation mode and the second amplitude modulation mode within each cycle of the rectified AC voltage. Of course, this means that the auxiliary SMPS 210 in this case is configured to switch between the first SMPS amplitude modulation mode and the second SMPS amplitude modulation mode within each cycle of the rectified AC voltage.

Moreover, the PFC circuit 210 may be further configured to switch from the second amplitude modulation mode to the first PFC amplitude modulation mode responsive to the rectified AC voltage no longer meeting the predetermined amplitude condition. Also, the auxiliary SMPS 220 may be further configured to switch from the second SMPS amplitude modulation mode to the first SMPS amplitude modulation mode responsive to the rectified AC voltage no longer meeting the predetermined amplitude condition (e.g., simultaneously/synchronously with the PFC circuit 210).

That is, the PFC circuit 210 and the auxiliary SMPS 220 may both switch/change back to normal/regular operation when the condition (i.e. the predetermined amplitude condition) is no longer met.

In a specific realisation of the invention, the PFC circuit 210 may be a step-down converter (e.g., a buck converter). In this case, the certain condition may comprise the rectified AC voltage falling below a first threshold voltage. In this case, the first signal pattern may be a voltage downward pulse with respect to the second ripple, and the second signal pattern may be a voltage upward pulse.

To clarify, this means that when the rectified AC voltage falls below a certain/predetermined threshold voltage, the PFC circuit 210 and the auxiliary SMPS 220 may switch to their second modes of operation. In those second modes of operation, the PFC circuit 210 produces a voltage downward pulse, and the auxiliary SMPS 220 produces a voltage upward pulse.

In one example, the first threshold voltage may be equal or less than a forward voltage of the load. As a result, the PFC circuit 210 (here: a buck circuit) is able to keep operating since the PFC circuit 210 just outputs a downward pulse with reduced amplitude, when the amplitude of the rectified AC voltage is less than the forward voltage of the load (e.g., LED lighting 230). This would not be the case if the PFC circuit 210 and the auxiliary SMPS 220 remained in their first (normal/regular) modes of operation in which case the PFC circuit 210 is not able to work since the input volage is already lower than a non-reduced output voltage.

Alternatively, the PFC circuit 210 may be a step-up converter (e.g., a boost converter). In this case, the certain condition may comprise the rectified AC voltage exceeding a second threshold voltage (i.e. a threshold voltage different from the first threshold voltage). For example, the first signal pattern may a voltage upward pulse with respect to the second ripple, and the second signal pattern may be a voltage downward pulse (i.e. opposite to when the PFC circuit 210 is a step-down converter).

In particular, the second threshold voltage may be equal or greater than a forward voltage of the load. As a result, the PFC circuit 210 would be able to keep operating when the amplitude of the rectified AC voltage is approximating or even higher than the forward voltage of the load (e.g., LED lighting 230). This would not be the case if the PFC circuit 210 and the auxiliary SMPS 220 remained in their first (normal/regular) modes of operation in which case the PFC circuit 210 is unable to work since the input volage is already higher than a non-increased output voltage.

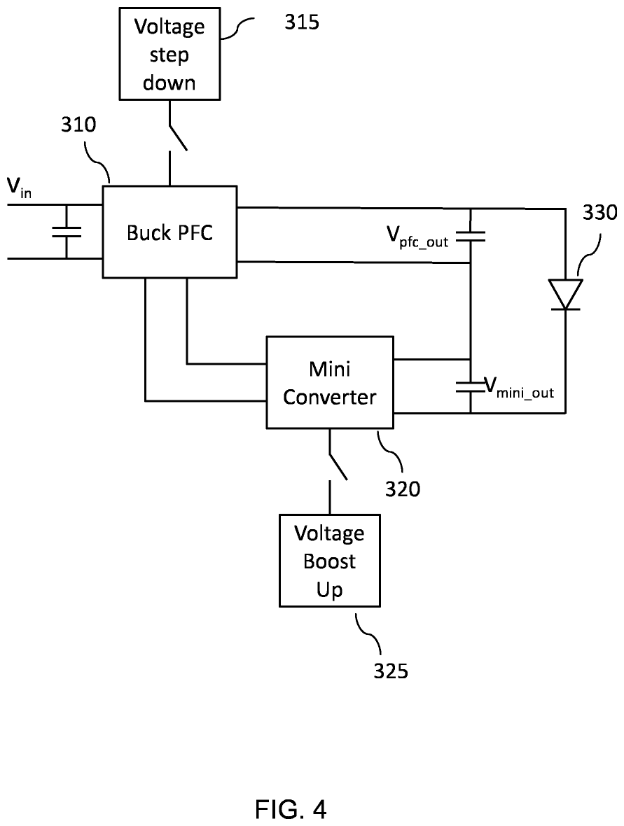

The above two examples are explained in further detail below with reference to FIGS. 4-7.

Moreover, in general the PFC circuit 210 operating in the second amplitude modulation mode may be adapted to modify the amplitude of the PFC output voltage provided in the first PFC amplitude modulation mode so as to maintain operation even when a difference between the amplitude of the rectified AC voltage and a voltage at the load is less than a threshold voltage. For example, if the PFC circuit is a buck converter, the input voltage can be just slightly larger, equal, or even smaller than the voltage the load. By comparison, the original buck PFC circuit requires that the input voltage is larger than the output voltage by at least some amount.

More specifically, in some cases the PFC circuit may be adapted to maintain operation when the difference is less than the threshold voltage by allowing a further difference between the amplitude of the rectified AC voltage and the PFC output voltage within an operable range. For example, in order to allow the input voltage to be just slightly larger, equal, or even smaller than the voltage the load, the PFC circuit's output voltage is stepped down so the input voltage is still larger than the PFC circuit output and the PFC circuit maintains operation. The stepped down PFC output voltage is compensated by the SMPS output voltage.

This ensures that the PFC circuit 210 maintains operation when the amplitude of the rectified AC voltage is different from the voltage amplitude of the load at least by said difference.

In a final modification, the PFC circuit 210 may be configured to switch from the first PFC amplitude modulation mode to the second amplitude modulation mode, and the auxiliary SMPS 220 may be configured to switch from the first SMPS amplitude modulation mode to the second SMPS amplitude modulation mode responsive to the rectified AC voltage meeting the certain condition (i.e., the predetermined amplitude condition), but only under a further condition that a forward voltage of the load meets a predetermined requirement. That is, the switching of the PFC circuit 210 and the auxiliary SMPS 220 may only occur when the forward voltage of the load (e.g., the LED lighting 230), meets a predetermined requirement. Otherwise, the PFC circuit is configured to stay in the first PFC amplitude modulation mode and the auxiliary SMPS may be configured to stay in the first SMPS amplitude modulation mode even responsive to the rectified AC voltage meeting the certain condition (i.e., the predetermined amplitude condition).

For example, when the PFC circuit 210 is a step-down converter (e.g., a buck converter), the predetermined requirement may be met when the forward voltage of the load/LED lighting 230 is higher than a first voltage level. If the forward voltage of the load 230 is less than the first voltage level, the PFC circuit 210 and auxiliary SMPS may not switch to their second modes and may maintain normal operation. This is because, when the forward voltage of the load 230 is less than said first voltage level, the downtime of operation of the PFC circuit may be minimal (and therefore switching modes may not be beneficial overall to the THD and efficiency). When the forward voltage of the load 230 drops too low, the downtime of operation of the PFC circuit becomes so severe and unacceptable that it needs to kick or operate in the second modes to correct it.

In an alternative example, when the PFC circuit 210 is a step-up converter and the predetermined requirement comprises the amplitude of the rectified AC voltage exceeding a forward voltage of the load (e.g., LED lighting 230), and the first signal pattern is a voltage upward pulse with respect to the second ripple, and the second signal pattern is a voltage downward pulse, the forward voltage of the load meeting the predetermined requirement may correspond to the load (e.g. LED lighting 230) being dimmed down thereby the forward voltage thereof decreases.

That is, given the above, the PFC circuit 210 and the auxiliary SMPS 220 will be able to switch a mode of operation if the forward voltage of the load is decreased. This forward voltage of the load decreasing corresponds to a dimming of the load/LED lighting 230. Accordingly, a deeper dimming of the load 230 is enabled whilst maintaining operation of the PFC circuit 210.

Of course, the above driving arrangement may be used in an LED lighting circuit comprising the driving arrangement, and an LED arrangement (i.e. one or more LEDs) as the load. Of course, additionally an LED lighting device may be provided comprising said LED lighting circuit.

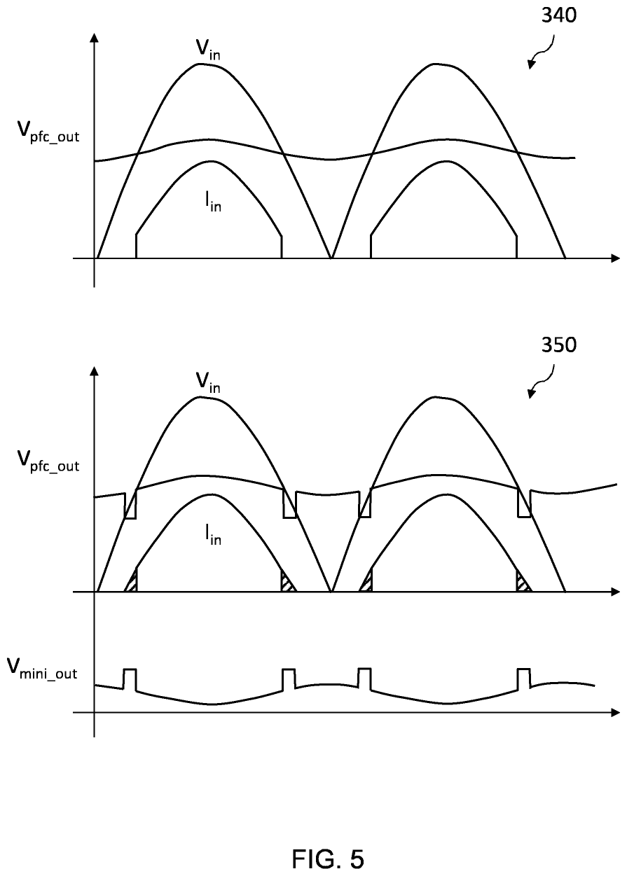

Turning to FIG. 4, there is presented a specific implementation of the proposed invention, with the key waveforms of the driving arrangement shown in FIG. 5.

By way of explanation, responsive to the AC input voltage (Vᵢₙ) dropping lower than a certain value, for example dropping close or below the PFC output voltage (V_{pfc_out}) generated for the ordinary PFC purpose, the PFC output voltage is decreased, while the mini converter 320 (i.e. an auxiliary SMPS) provides a boost up pattern in its output voltage (V_{mini_out}) to compensate for the decreased PFC output voltage to keep the load current constant in the load (e.g., an LED arrangement). This may increase the conduction time of the PFC circuit, reduce the deadtime of input current, and improve THD. In this embodiment, a voltage step down block 315 with a switch connected to the PFC circuit 310 is shown. The switch is logically closed to apply the voltage step down function to the PFC circuit to generate a step down signal pattern in the PFC output, in proper time duration. Similarly, a voltage boost up block 325 with a switch connected to the mini converter 320 is shown. The switch is logically closed to apply the voltage boost up function to the mini converter to generate a boost up signal pattern, in proper time duration. To be noted, the voltage boost up block and the corresponding switch as shown is logically/functionally, and there could be either a real physical circuit to boost up the output voltage from the mini converter, or the mini converter uses its own control loop to boost up its output voltage. Both implementations fall into the scope of the invention.

Graph 340 of FIG. 5 presents the key waveforms of a typical buck converter driver as reference, while graph 350 presents the key waveforms of the driver of FIG. 4. As seen when comparing graph 340 and 350 of FIG. 5, by way of specific example, when Vᵢₙ is greater than 91.5V, and lower than 128V, the second modes are activated to override the first modes. In this the implementation of the invention, the second mode of the PFC circuit forms a step down pattern in the PFC output voltage V_{pfc_out} and may increase conduction time of Iᵢₙ (shaded region of graph 320).

The voltage boost up block/second mode of the SMPS converter may generate a voltage step up pattern in the offset signal V_{mini_out}, to compensate the voltage drop of PFC output. In this case, the working time is

$$\frac{arcsin \frac{128}{230 * \sqrt{2}} - arcsin \frac{91.5}{230 * \sqrt{2}}}{180} * 10 = 0.3 \; 88 ms .$$

When Vᵢₙ is less than 91.5V or greater than 128V, the boost up block 325 may stop operating, and the buck converter/PFC circuit 310 directly outputs to the LED voltage.

Since the mini converter may be designed with the ordinary SMPS output V_{mini_out} without the boost up pattern, the efficiency of the mini converter 320 at this normal operation is 85%, and this efficiency may become lower if the mini converter is adapted to generate the boost up pattern. In simulation, the equivalent overall efficiency of mini converter 320 equals 84.1% when it outputs the offset signal including the boost up pattern. Further, the mini converter 320 only delivers a small part of the total power to the LED 330. Thus, assuming the portion of total power delivered by mini converter 320 is 10%, and the PFC stage 310 efficiency is 97%, the equivalent efficiency of the driver is 95.4%. The efficiency when Vᵢₙ is 128V is 95.5%. Thus, there is only 0.1% efficiency difference, so the proposed driving arrangement has a limited influence on efficiency, but gains a large improvement on THD.

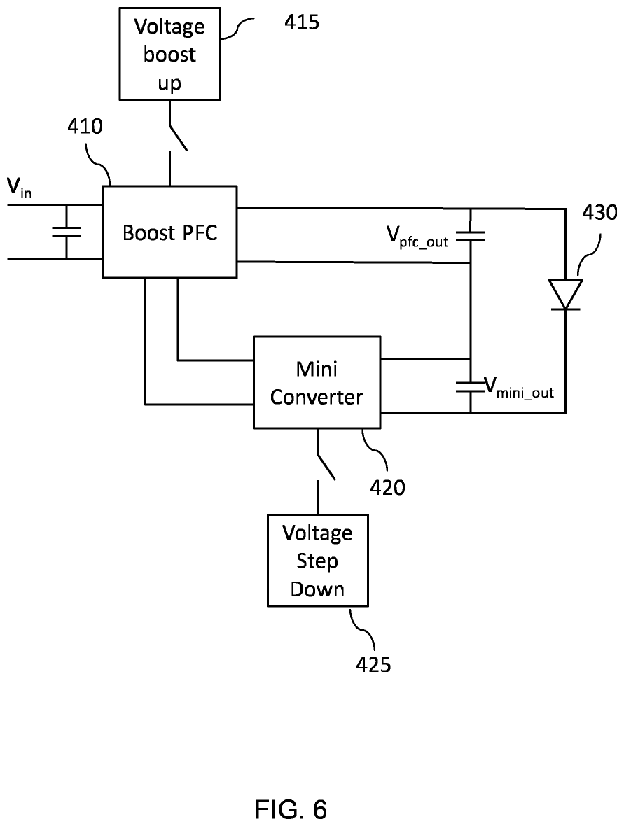

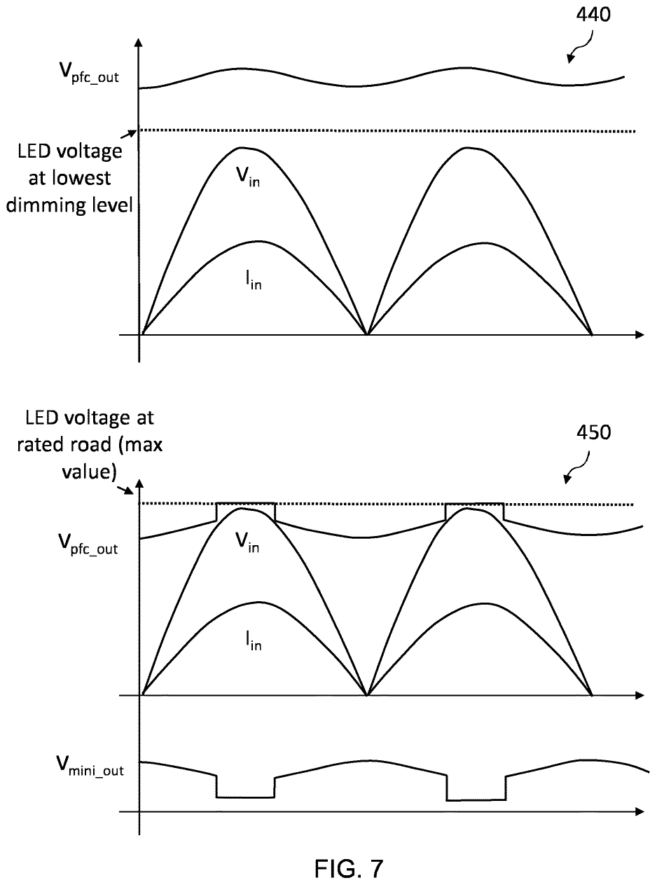

Similarly to FIG. 4, FIG. 6 presents a specific implementation of the proposed invention, with the key waveforms of the driving arrangement shown in FIG. 7.

As shown in graph 440 of FIG. 7, in a typical driving arrangement, the boost PFC output voltage must be much greater than the maximum peak value of AC input voltage when the LED is at a full load (i.e., undimmed) condition. A product is designed under such a working condition. But when the LED is dimmed down, its forward voltage drops and so is the boost PFC output voltage which is clamped by the forward voltage, thus it is not guaranteed that the PFC output voltage in dimmed state is greater than the AC input voltage at deep dimming and the boost converter may stop operation. Thus, an output capacitor will need to be high in cost and size to compensate for this.

However, this problem may be overcome by the arrangement of FIG. 6. The PFC output bus voltage can be set approximate to the maximum AC input voltage, which may be equivalent to the LED voltage at full load (undimmed condition). During a dimming load condition, the LED voltage will likely be lower than AC input voltage (particularly when the AC input voltage is near the peak value). Thus, when the transient value of input AC voltage is lower than PFC output voltage, the boost PFC 410 operates normally. However, when the input transient AC voltage is higher than the LED voltage, the boost PFC circuit's output voltage is increased, by activating the second mode/voltage boost up block 415 to the boost PFC, to the peak value of input AC voltage maximum value or even higher to enable boost to operate normally. In this case, the mini converter 420 is configured with the second mode/voltage step down block 425 to generate a step down pattern to compensate for the increased voltage pattern of the PFC output voltage so as to provide constant voltage/current to the LED load 430 together with the boost PFC 410. Thus the capacitor's rated voltage may be much lower during the normal boost condition, thus reducing a required size and cost. This may also facilitate a deeper dimming depth.

The mere fact that certain measures are recited in mutually different dependent claims does not indicate that a combination of these measures cannot be used to advantage.

Any reference signs in the claims should not be construed as limiting the scope.

1. A driving arrangement for LED lighting, comprising:
an input adapted to receive a rectified AC voltage having a first ripple corresponding to a frequency of the rectified AC voltage;
a power factor correction, PFC, circuit configured to be operable in a first PFC amplitude modulation mode in which the PFC circuit converts the rectified AC voltage into a PFC output voltage for implementing power factor correction, the PFC circuit comprising a following circuit to make the PFC output voltage having a second ripple corresponding to the frequency of the rectified AC voltage and following the first ripple; and
an auxiliary switched mode power supply, SMPS, configured to generate an offset signal provided in series with the PFC output voltage to produce a superimposed signal for application to a load, wherein the auxiliary SMPS is configured to be operable in a first SMPS amplitude modulation mode to generate, in the offset signal, a third ripple out of phase with the second ripple such that the superimposed signal has a smoothed second ripple, and
wherein, responsive to the rectified AC voltage in a sub-optimal range which can not satisfy an operating condition, between the rectified AC voltage and the PFC output voltage, of the PFC circuit:
the PFC circuit is further configured to switch from the first PFC amplitude modulation mode to a second amplitude modulation mode in which the PFC circuit further comprising a generating circuit to generate in the PFC output voltage a first signal pattern corresponding to the frequency of the rectified AC voltage and different from the second ripple, with which first signal pattern the operating condition is satisfied so as to keep the PFC circuit operating; and
the auxiliary SMPS is further configured to switch from the first SMPS amplitude modulation mode to a second SMPS amplitude modulation mode in which the auxiliary SMPS generates a second signal pattern in the offset signal, the second signal pattern different from the third ripple and adapted to compensate for the first signal pattern.

2. The driving arrangement of claim 1, wherein the PFC circuit operating in the second amplitude modulation mode is adapted to modify the amplitude of the PFC output voltage provided in the first PFC amplitude modulation mode so as to maintain operation when a difference between the amplitude of the rectified AC voltage and a voltage at the load is less than a threshold voltage.

3. The driving arrangement of claim 2, wherein the PFC circuit is adapted to operate when the difference is less than the threshold voltage by allowing a further difference between the amplitude of the rectified AC voltage and the PFC output voltage within an operable range of the PFC circuit, thereby ensuring the PFC circuit maintains operation when the amplitude of the rectified AC voltage is varying from the voltage amplitude of the load at least by said difference.

4. The driving arrangement of claim 1, wherein:
responsive to the rectified AC voltage in the sub-optimal range comprising the instantaneous amplitude of the rectified AC voltage in the sub-optimal range, the PFC circuit is configured to switch between the first PFC amplitude modulation mode and the second amplitude modulation mode within each cycle of the rectified AC voltage, and the auxiliary SMPS is configured to switch between the first SMPS amplitude modulation mode and the second SMPS amplitude modulation mode within each cycle of the rectified AC voltage, and/or
responsive to the rectified AC voltage in the sub-optimal range comprising the time average amplitude of the rectified AC voltage in the sub-optimal range, the PFC circuit is configured to switch between the first PFC amplitude modulation mode and the second amplitude modulation mode across multiple cycles of the rectified AC voltage, and the auxiliary SMPS is configured to switch between the first SMPS amplitude modulation mode and the second SMPS amplitude modulation mode across multiple cycles of the rectified AC voltage.

5. The driving arrangement of claim 1, wherein the PFC circuit is a step-down converter, wherein the sub-optimal range comprises the rectified AC voltage falling below a first threshold voltage, and the first signal pattern is a voltage downward pulse with respect to the second ripple, and the second signal pattern is a voltage upward pulse.

6. The driving arrangement of claim 5, wherein the step-down converter is a buck converter, and the first threshold voltage is equal or less than a forward voltage of the load, thereby the PFC circuit is able to keep operating when the amplitude of the rectified AC voltage is less than the forward voltage of the load.

7. The driving arrangement of claim 1, wherein the PFC circuit is a step-up converter, wherein the the sub-optimal range comprises the rectified AC voltage exceeding a second threshold voltage, and the first signal pattern is a voltage upward pulse with respect to the second ripple, and the second signal pattern is a voltage upward pulse.

8. The driving arrangement of claim 7, wherein the step-up converter is a boost converter, and the second threshold voltage is equal or greater than a forward voltage of the load, thereby the PFC circuit is able to keep operating when the amplitude of the rectified AC voltage is approaching or higher than the forward voltage of the load.

9. The driving arrangement of claim 1, wherein the PFC circuit is configured to switch from the first PFC amplitude modulation mode to the second amplitude modulation mode and the auxiliary SMPS is configured to switch from the first SMPS amplitude modulation mode and the second SMPS amplitude modulation mode responsive to the rectified AC voltage in the sub-optimal range, under a condition that a forward voltage of the load meets a predetermined requirement; otherwise
the PFC circuit is configured to stay in the first PFC amplitude modulation mode and the auxiliary SMPS is configured to stay in the first SMPS amplitude modulation mode even responsive to the rectified AC voltage in the sub-optimal range.

10. The driving arrangement of claim 9, wherein the PFC circuit is a step-down converter, and wherein the predetermined requirement is met when the forward voltage of the load is higher than a first voltage level when the PFC circuit is a step-down converter.

11. The driving arrangement of claim 9, wherein the PFC circuit is a step-up converter, the sub-optimal range comprises the amplitude of the rectified AC voltage exceeding a forward voltage of the load, and the load is an LED, and
wherein the first signal pattern is a voltage upward pulse with respect to the second ripple, and the second signal pattern is a voltage downward pulse,
wherein the forward voltage of the load meeting the predetermined requirement corresponds to the LED being dimmed down thereby the forward voltage thereof decreases.

12. The driving arrangement of claim 1, wherein, responsive to the rectified AC voltage no longer in the sub-optimal range:
the PFC circuit is further configured to switch from the second amplitude modulation mode to the first PFC amplitude modulation mode; and
the auxiliary SMPS is further configured to switch from the second SMPS amplitude modulation mode to the first SMPS amplitude modulation mode.

13. An LED lighting circuit comprising the driving arrangement of claim 1, and an LED arrangement as the load.

14. An LED lighting device comprising the LED lighting circuit of claim 13.
